(19) United States
(12) Patent Application Publication
(10) Pub. No.: US 2011/0119717 A1
(43) Pub. Date: May 19, 2011

(54) ELECTRONIC DEVICE AND METHOD FOR OBTAINING WORKING STATES OF ELECTRONIC APPRATUSES THEREOF

(75) Inventor: LUNG DAI, Tu-Cheng (TW)

(73) Assignee: HON HAI PRECISION INDUSTRY CO., LTD., Tu-Cheng (TW)

(21) Appl. No.: 12/914,917

(22) Filed: Oct. 28, 2010

(30) Foreign Application Priority Data
Nov. 17, 2009 (CN) 200910309850.9

(51) Int. Cl. H04N 7/18; H04N 5/44

(52) U.S. Cl. 725/80; 348/734

(57) ABSTRACT

An electronic device includes a first receiving unit and a processing unit. The first receiving unit receives a plurality of detection signals respectively from a plurality of electronic apparatuses, the detection signals respectively indicates the working states of all electronic apparatuses. The processing unit outputs the detection signals to an output unit, thus the output unit defines the working states of all electronic apparatuses. A related method is also provided.

### BACKGROUND

1. Technical Field

The disclosed embodiments relate to electronic devices, and particularly to an electronic device and a method for obtaining the working states of a plurality of electronic apparatuses.

2. Description of Related Art

Generally, electronic apparatuses, such as air conditioners, washing machines, and refrigerators, are placed in different positions of a house. Therefore, it is not easy for users to simultaneously know the working states of all electronic apparatuses, for example the temperature of the air conditioner, the operation state of the washing machine, and the temperature of the refrigerator.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout four views.

FIG. 1 is a schematic diagram showing a system for prompting working states of a plurality of electronic apparatuses in accordance with an exemplary embodiment, the system includes the electronic apparatuses, an electronic device and a output unit.

FIG. 2 is a block diagram showing the electronic device and the output unit of FIG. 1.

FIG. 3 is a chart showing the working states of the electronic apparatuses of FIG. 1.

FIG. 4 is a flow chart illustrating a method for prompting working states of a plurality of electronic apparatuses in accordance with an exemplary embodiment.

### DETAILED DESCRIPTION

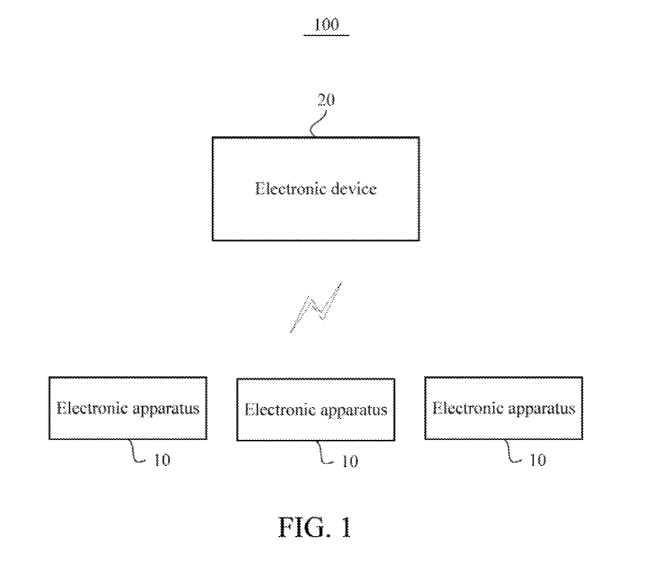

Referring to FIG. 1, a system 100 for obtaining working states of a plurality of electronic apparatuses 10 is illustrated. The system 100 includes the electronic apparatuses 10 and an electronic device 20.

The electronic apparatuses 10 may include an air conditioner, a washing machine or a refrigerator, etc. The working states of the electronic apparatuses 10 correspondingly include the temperature of the air conditioner, the operation state of the washing machine, and the temperature of the refrigerator.

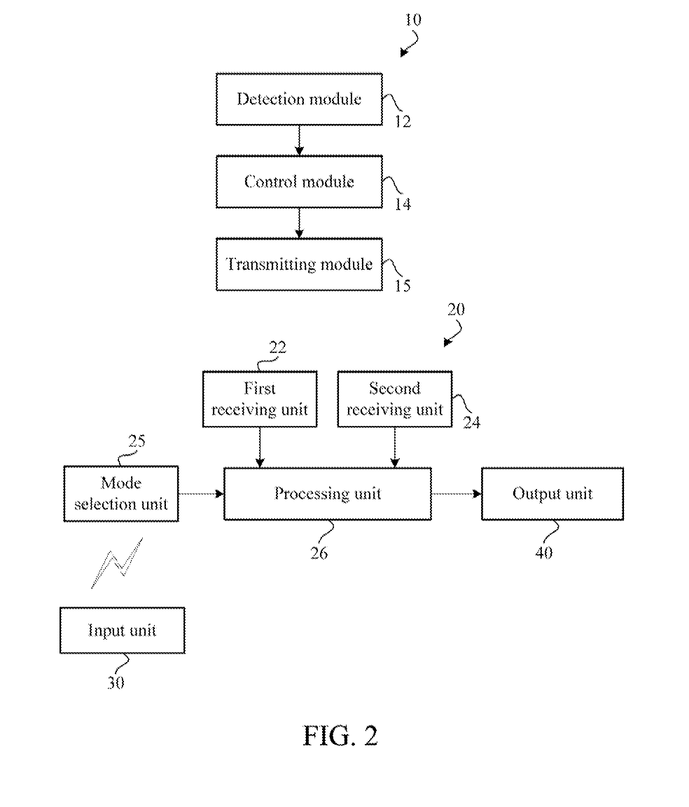

Referring to FIG. 2, the electronic apparatus 10 includes a detection module 12, a control module 14, and a transmitting module 15. The detection module 12 is used for detecting the working state of the electronic apparatus 10 and generating a detection signal. The control module 14 is used for controlling the transmitting module 15 to transmit the detection signal to the electronic device 20. In this embodiment, the detection module 12 can be a sensor.

The electronic device 20 includes a first receiving unit 22, a second receiving unit 24, a mode selection unit 25, a processing unit 26, an input unit 30, and an output unit 40. In this embodiment, the input unit 30 can be a button disposed on the electronic device 20.

The first receiving unit 22 is used for receiving the detection signals respectively from the electronic apparatuses 10. The second receiving unit 24 is used for receiving television signals. The mode selection unit 25 is used for receiving a command from the input unit 30, and controlling the processing unit 26 to be switched from a first mode to a second mode or from the second mode to the first mode according to the received command. In the first mode, the processing unit 26 outputs the detection signals to the output unit 40, and the output unit 40 reproduces the working states of all electronic apparatuses 10 in visible or audible form according to the detection signals, thus it is easy for a user to simultaneously knows the working states of all electronic apparatuses 10. In the second mode, the processing unit 26 processes the television signals and outputs the processed television signals to the output unit 40, the output unit 40 broadcasts television programs according to the processed television signals.

In other embodiments, the input unit 30 and the output unit 40 are independent from the electronic device 20, the electronic device 20 can be a set top box, the input unit 30 can be a remote controller, and the output unit 40 can be a television, the detection module 12 detects the working state of the electronic apparatus 10 and generates the detection signal according to a command from the input unit 30.

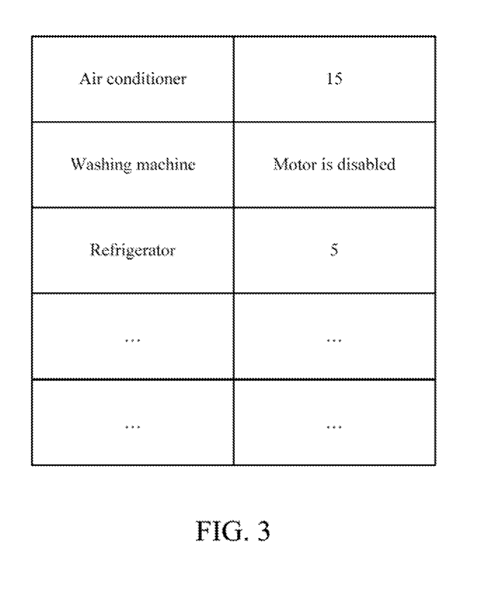

Referring to FIG. 3, the output unit 40 simultaneously displays that the temperature of the air conditioner is 15 degrees centigrade, the motor of the washing machine is disabled, and the temperature of the refrigerator is 5 degrees centigrade. Therefore, users can simultaneously know the working states of all electronic apparatuses 10 with the electronic device 20.

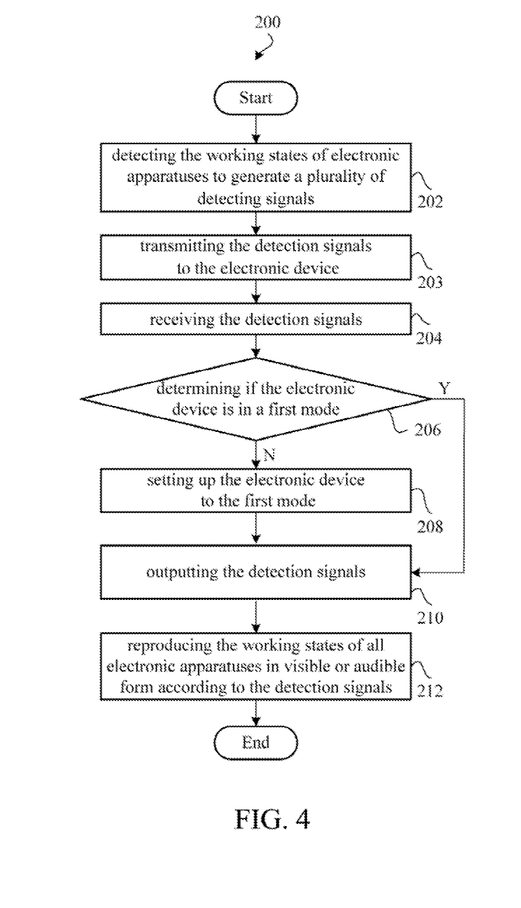

Referring to FIG. 4, a method 200 for obtaining working states of a plurality of electronic apparatuses 10 is illustrated, the method 200 includes the following steps:

Step 202, detecting the working states of the electronic apparatuses 10 to respectively generate a plurality of detection signals. In this embodiment, each electronic apparatus 10 has a sensor 12 for detecting the working state thereof. In other embodiments, the working states of the electronic apparatuses 10 are detected according to a command from an input unit 30, the input unit 30 can be a remote controller or a button disposed on the electronic device 20.

Step 203, the electronic apparatuses 10 respectively transmit the detection signals to the electronic device 20.

Step 204, the electronic device 20 receives the detection signals respectively from the electronic apparatuses 10.

Step 206, determining if the electronic device 20 is in a first mode. The electronic device 20 is capable of being switched from the first mode to the second mode, in the first mode, the electronic device 20 outputs the detection signals to an output unit 40, and the output unit 40 reproduces the working states of all electronic apparatuses 10 in visible or audible form according to the detection signals; in the second mode, the electronic device 20 receives television signals and outputs the television signals to the output unit 40, and the output unit 40 broadcasts television programs according to the television signals. In other embodiments, the electronic device 20 includes an output unit 40, in the first mode, the electronic device 20 reproduces the working states of all electronic apparatuses 10 in visible or audible form according to the detection signals; in the second mode, the electronic device 20 receives television signals and broadcasts television programs according to the television signals. If the electronic device 20 is in the first mode, the procedure goes to step 208. If the electronic device 20 is in the second mode, the procedure goes to step 210.

Step 208, setting up the electronic device 20 to the first mode according to a command from the input unit 30.

Step 210, outputting the detection signals.

Step 212, reproducing the working states of all electronic apparatuses 10 in visible or audible form according to the detection signal.

Further alternative embodiments will become apparent to those skilled in the art without departing from the spirit and scope of what is claimed. Accordingly, the present invention should be deemed not to be limited to the above detailed description, but rather only by the claims that follow and equivalents thereof.

What is claimed is:

1. A method for obtaining working states of a plurality of electronic apparatuses, the method comprising:
an electronic device establishing a communication connection with the electronic apparatuses;
the electronic device receiving a plurality of detection signals respectively from the electronic apparatuses;
the electronic device outputting the detection signals for defining the working states of all electronic apparatuses.

2. The method as claimed in claim 1, further comprising:
detecting a working state of each of the electronic apparatuses to respectively generate the detection signals;
transmitting the detection signals to the electronic device.

3. The method as claimed in claim 2, wherein the step of detecting working state of each of the electronic apparatuses is performed by disposing a sensor on each of the electronic apparatuses.

4. The method as claimed in claim 2, wherein the working state of each of the electronic apparatuses is detected according to a command from an input unit.

5. The method as claimed in claim 4, wherein the input unit is a remote controller or a button disposed on the electronic device.

6. The method as claimed in claim 1, wherein the electronic device is capable of being switched from a first mode to a second mode; in the first mode, the electronic device reproduces the working states of all electronic apparatuses in visible or audible form according to the detection signals; in the second mode, the electronic device receives television signals and broadcasts television programs according to the television signals.

7. The method as claimed in claim 6, wherein the electronic device is switched from the first mode to the second mode according to a command from an input unit, and the input unit is a remote controller or a button disposed on the electronic device.

8. The method as claimed in claim 1, wherein the electronic device is capable of being switched from a first mode to a second mode; in the first mode, the electronic device outputs the detection signals to an output unit; in the second mode, the electronic device receives television signals, and outputs the television signals to the output unit.

9. The method as claimed in claim 8, wherein the output unit reproduces the working states of all electronic apparatuses in visible or audible form according to the detection signals, and broadcasts television programs according to the television signals.

10. The method as claimed in claim 9, wherein the electronic device is a set top box, and the output unit is a television.

11. The method as claimed in claim 8, wherein the electronic device is switched from the first mode to the second mode according to a command from an input unit, and the input unit is a remote controller or a button disposed on the electronic device.

12. The method as claimed in claim 1, wherein the electronic apparatuses include an air conditioner, a washing machine and a refrigerator, and the working states of the electronic apparatuses include a temperature of the air conditioner, an operation state of the washing machine, and a temperature of the refrigerator.

13. An electronic device, comprising:
a first receiving unit for receiving a plurality of detection signals respectively from a plurality of electronic apparatuses, the detection signals respectively indicating working states of all electronic apparatuses;
a processing unit for outputting the detection signals to an output unit, thus the output unit defining the working states of all electronic apparatuses.

14. The electronic device as claimed in claim 13, wherein the output unit reproduces the working states of all electronic apparatuses in visible or audible form according to the detection signals.

15. The electronic device as claimed in claim 14, further comprises a second receiving unit for receiving television signals, the processing unit is capable of being switched from a first mode at which the detection signals are outputted to the output unit to a second mode at which the television signals are processed; and the output unit broadcasts television programs according to the processed television signals.

16. The electronic device as claimed in claim 15, further comprising a mode selection unit for controlling the processing unit to be switched from the first mode to the second mode according to a command from an input unit.

17. The electronic device as claimed in claim 16, wherein the input unit is a remote controller or a button disposed on the electronic device.

18. The electronic device as claimed in claim 13, further comprising a second receiving unit for receiving television signals, wherein the processing unit is capable of being switched from a first mode at which the detection signals are outputted to an output unit to a second mode at which the television signals are processed; and the output unit reproduces working states of all electronic apparatuses in visible or audible form according to the detection signals and broadcasts television programs according to the processed television signals.

19. The electronic device as claimed in claim 18, further comprising a mode selection unit for controlling the processing unit to be switched from the first mode to the second mode according to a command from an input unit.

20. The electronic device as claimed in claim 19, wherein the input unit is a remote controller or a button disposed on the electronic device, the electronic device is a set top box, and the output unit is a television.
